(19) United States
(12) Patent Application Publication
(10) Pub. No.: US 2025/0037100 A1
(43) Pub. Date: Jan. 30, 2025

(54) SALES DATA PROCESSING APPARATUS AND SALES DATA PROCESSING METHOD

(71) Applicant: Toshiba Tec Kabushiki Kaisha, Tokyo (JP)

(72) Inventor: Hiroshi SHIMADA, Tagata Shizuoka (JP)

(21) Appl. No.: 18/740,315

(22) Filed: Jun. 11, 2024

(30) Foreign Application Priority Data
Jul. 24, 2023 (JP) 2023-120255

(51) Int. Cl. G06Q 20/20

(52) U.S. Cl. CPC G06Q 20/204; G06Q 20/201

(57) ABSTRACT

According to one embodiment, a sales data processing apparatus has a communication interface and a processor. The processor acquires settlement data associated with a code symbol from a customer terminal. The settlement data includes information for completing a code settlement payment for a sales transaction which is transmitted via the communication interface to an external server providing a settlement proxy service. The processor receives a settlement result notification via the communication interface from the external server. The settlement result notification includes a code settlement brand used for the code settlement payment. The processor compares the code settlement brand to a listing of approved brands and outputs a notification that the code settlement payment was performed using an unapproved code settlement brand if the code settlement brand included in the settlement result notification does not match an approved brand on the listing.

### CROSS-REFERENCE TO RELATED APPLICATION

This application is based upon and claims the benefit of priority from Japanese Patent Application No. 2023-120255, filed Jul. 24, 2023, the entire contents of which are incorporated herein by reference.

### FIELD

Embodiments described herein relate generally to a sales data processing apparatus and a sales data processing method for retail stores and the like.

### BACKGROUND

In the related art, in a store where commodities are sold, settlement processing is performed using a sales data processing apparatus such as a POS terminal. In recent years, code settlement, which is an electronic settlement method using a code symbol (such as a two-dimensional barcode or the like), has been widely adopted, and a sales data processing apparatus for code settlement is also available. For example, there is proposed a sales data processing apparatus that requests an external server to perform code settlement for a particular payment amount by transmitting the data read from a code settlement symbol displayed on a customer's smartphone of a customer to the external server along with the payment amount. The external server thus provides a settlement proxy service.

In general, there are many code settlement brands (hereinafter, also simply referred to as brands) that provide a code settlement service, however, some stores, depending on the store, might permit use of only some code settlement brands. A customer must thus use one of the store's accepted brands for settlement, but may provide a code symbol of an unapproved brand due to an erroneous operation, misunderstanding, or the like. In such a case, if data read from the code symbol of an unapproved brand is transmitted to the external server and the external server supports the code settlement by the unapproved brand, the code settlement may be performed even though the brand is not actually acceptable on the store's side.

In such a case, in the store, from the viewpoint of customer convenience, if a settlement result of the external server indicates a settlement completion (settlement success), the transaction might not be cancelled even though the unapproved brand was used, and the transaction can be completed as usual. On the store side, it is usually necessary to perform additional post-processing related to the unapproved brand use such as payment of a service fee later to the unapproved brand that was used for the code settlement.

However, when the code settlement of the unapproved brand is allowed, the sales data processing apparatus generally handles a code settlement result for the unapproved brand similarly to a code settlement result for an approved brand, and thus it may be difficult for a store clerk or manager to recognize which transaction(s) the unapproved brand was used in settlement processing. Therefore, on the store side, when the post-processing is performed, it is not possible to easily identify and extract a transaction in which an unapproved brand was used, and further improvement in related systems and methods may be desired from the viewpoint of processing efficiency on the store side.

### BRIEF DESCRIPTION OF THE DRAWINGS

FIG. 1 is a diagram showing an example of a sales data processing system according to an embodiment.

FIG. 2 is a diagram showing an example of a hardware configuration of a POS terminal.

FIG. 3 is a diagram showing an example of a data configuration of approved brand information.

FIG. 4 is a diagram showing an example of a hardware configuration of a store server.

FIG. 5 is a diagram showing an example of a hardware configuration of a customer terminal.

FIG. 6 is a diagram depicting certain functional aspects of a POS terminal, a store server, and a customer terminal.

FIG. 7 is a diagram showing an example of a screen displayed on a display unit of a POS terminal.

FIG. 8 is a diagram showing an example of a store-reserved receipt.

FIG. 9 is a diagram showing an example of a store-reserved receipt.

FIG. 10 is a sequence diagram showing an example of sales data processing.

FIG. 11 is a flowchart showing an example of sales data processing to be performed.

### DETAILED DESCRIPTION

In general, according to certain embodiments, a sales data processing apparatus and a sales data processing method providing a technological solution for improving identifiability of a transaction in which an unapproved code settlement brand is used are described.

According to one embodiment, a sales data processing apparatus includes a communication interface and a processor. The processor is configured to: acquire settlement data associated with a code symbol read from a customer terminal, the settlement data including information for completing a code settlement payment for a sales transaction; transmit the settlement data via the communication interface to an external server that provides a settlement proxy service of the code settlement payment; receive a settlement result notification via the communication interface from the external server, the settlement result notification including a code settlement brand used for the code settlement payment; compare the code settlement brand in the settlement result notification to a listing of approved brands; and output a notification that the code settlement payment was performed using an unapproved code settlement brand when the code settlement brand included in the settlement result notification does not match an approved brand on the listing.

Hereinafter, certain example embodiments will be described with reference to the drawings. In an embodiment, a POS terminal used in a store selling commodities (a retail store) will be described as an example. The disclosure is not limited to this particular embodiment. For example, the item to be sold is not limited to a tangible commodity, and may instead or also be an intangible service or the like.

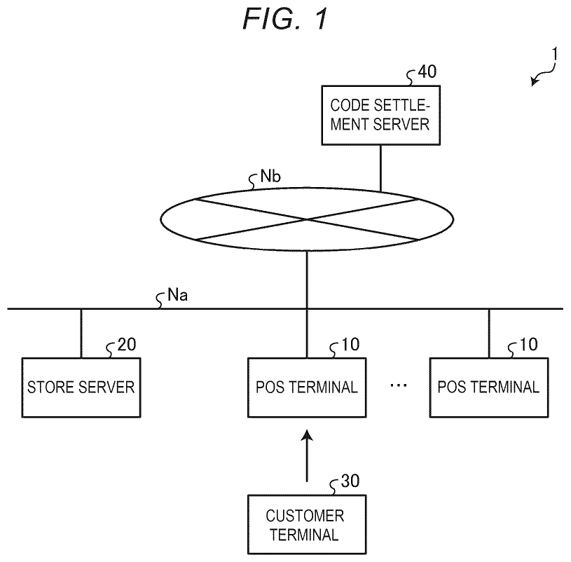

FIG. 1 is a diagram showing an example of a sales data processing system according to an embodiment. A sales data processing system 1 includes point of sales (POS) terminals 10, a store server 20, a customer terminal 30, and a code settlement server 40.

The POS terminal 10 and the store server 20 are communicably connected via a network Na, such as a local area network (LAN), provided in a store. The POS terminal 10 and the code settlement server 40 are communicably connected via a network Nb, such as the Internet or a dedicated line.

The POS terminal 10 is an example of a sales data processing apparatus. For example, one or a plurality of POS terminals 10 are installed in a checkout area of a store. The POS terminal 10 reads a code symbol, such as a bar code or a two-dimensional code attached to a commodity, and acquires a commodity code capable of identifying the commodity. The commodity code is an example of commodity identification information such as a JAN code (Japanese Article Number).

The POS terminal 10 executes, based on the commodity code of the commodity, registration processing on the commodity being purchased by a customer. In this context, registration processing refers to processes of reading a commodity name, a price, and the like corresponding to a commodity code from a commodity master 142 and storing the commodity name, the price, and the like in an RAM 13 or the like.

The POS terminal 10 starts settlement processing on the commodities registered in the registration processing in response to a closing operation such as an operation of instructing of a completion of the registration processing or an operation of instructing of a start of settlement. In this context, settlement processing refers to processes of calculating a total amount due for the commodities being purchased by the customer based on commodity information registered in the registration processing and settling the total amount by a payment made by the customer. Here, payment methods are not limited to cash payment and other payment methods such as by a credit card may be used. In the POS terminal 10 according to the embodiment, by cooperating with the code settlement server 40, payments can also be made by code settlement.

In addition, the POS terminal 10 dispenses, from a printer 18, a customer receipt on which the commodity information and settlement information (e.g., the total amount, the payment amount, a change amount, and the like) of items (commodities) subjected to the settlement processing are printed. The printer 18 may also dispense or generate a “store-reserved” receipt at this time.

The POS terminal 10 also transmits, to the store server 20, the commodity information and accounting information (collectively referred to as transaction data) of the items subjected to the settlement processing. The timing of transmitting the transaction data from the POS terminal 10 to the store server 20 is not particularly limited. For example, the transaction data may be transmitted when the settlement processing is completed or the transaction data for one day may be transmitted collectively when the store is closed.

The store server 20 is installed, for example, in a backroom of a store. The store server 20 stores a commodity master in which a commodity name, a price, a commodity image, and the like are associated in association with a commodity code for each commodity sold in the store. The store server 20 provides each POS terminal 10 with a commodity master. For example, the store server 20 transmits the commodity master to each of the POS terminals 10 for local storage in the POS terminal 10. In other examples, the store server 20 stores the commodity master and permits each POS terminal 10 to access the commodity master on the store server.

The store server 20 collects the transaction data received from the POS terminals 10. The store server 20 manages (tracks) sales of commodities in the store based on the collected transaction data and extracts transaction data for each code settlement brand (hereinafter, also simply referred to as a brand) used in code settlement.

The customer terminal 30 is a terminal device used by a customer who visits the store. In an embodiment, the customer terminal 30 is a mobile terminal such as a smartphone owned by a customer. It is assumed that an application for using a code settlement service (hereinafter, also referred to as a code settlement application) is introduced in the customer terminal 30 in advance. When performing code settlement, the customer operates the customer terminal 30 to activate the code settlement application, which causes display of a code symbol for the code settlement (hereinafter, also referred to as a settlement code symbol). The customer then permits the POS terminal 10 to read the settlement code symbol from the customer terminal 30. The brand or type of the code settlement application in the customer terminal 30 is not limited to a particular one, and may be for a plurality of brands.

The code settlement server 40 in this example is a server device that provides a settlement proxy service for a plurality of brands. The code settlement server 40 cooperates with the POS terminal 10 for implementing the settlement processing using a code settlement.

In the sales data processing system 1 in the present embodiment, the POS terminal 10 is caused to read the settlement code symbol provided on (or by) the customer terminal 30, so that transaction can be paid using code settlement.

Next, the configurations of the POS terminal 10, the store server 20, and the customer terminal 30 of the sales data processing system 1 will be described.

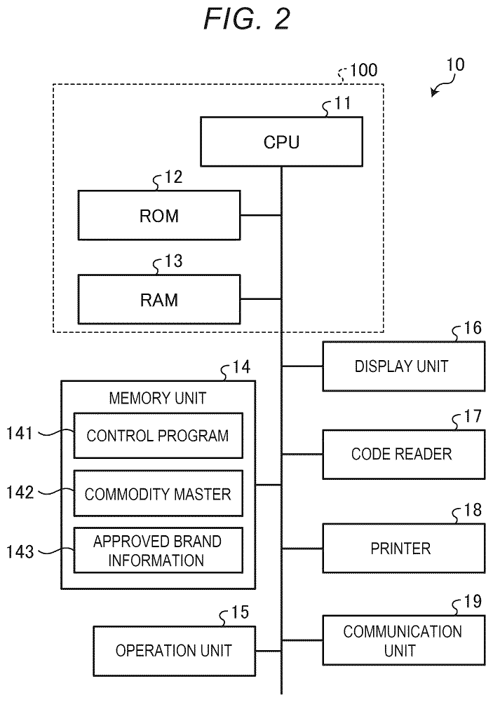

FIG. 2 is a diagram showing an example of the hardware configuration of a POS terminal 10. As shown in FIG. 2, the POS terminal 10 includes a central processing unit (CPU) 11, a read only memory (ROM) 12, the random access memory (RAM) 13, and a memory unit 14.

The CPU 11 is an example of a processor and comprehensively controls operations of the POS terminal 10. The ROM 12 stores various programs executable by the CPU 11. The RAM 13 is a work area for temporarily storing programs and various kinds of data. For example, the RAM 13 stores the commodity code, the commodity information, and the like of the commodity subjected to the registration processing.

The memory unit 14 is implemented as a nonvolatile memory such as a hard disk drive (HDD) or a flash memory in which stored information is held even when a power supply is turned off. The memory unit 14 stores various programs executable by the CPU 11, setting information, and the like. For example, the memory unit 14 stores a control program 141 executable by the CPU 11, the commodity master 142, and the like. The commodity master 142 has a commodity code for each commodity sold in the store and stores commodity information corresponding to the commodity code. The commodity information includes, for example, a commodity name and a price (a unit price).

The memory unit 14 stores approved brand information 143 indicating one or more code settlement brands approved to be used in the store. In other words, brands not included in the approved brand information 143 are brands that are not approved by the store. An approved brand can be a brand of a code settlement service company that enters into a usage agreement with the store or the like.

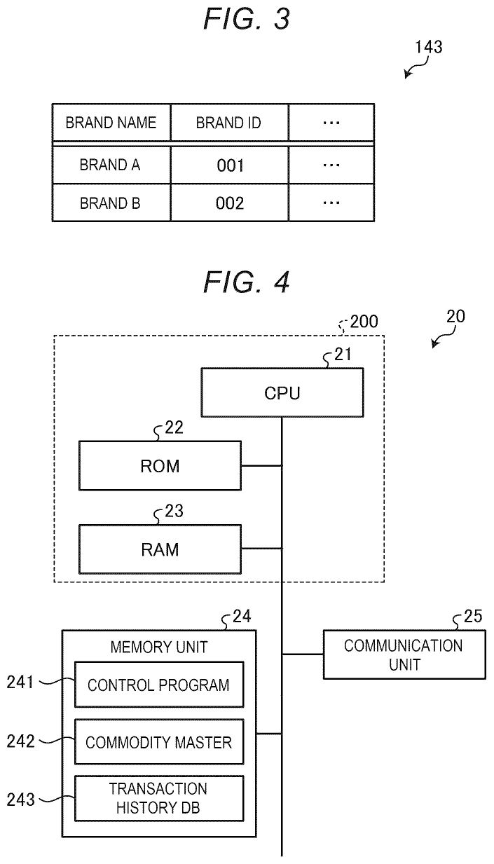

FIG. 3 is a diagram showing an example of a data configuration of the approved brand information 143. As shown in FIG. 3, in the approved brand information 143, information (hereinafter, also referred to as brand information) capable of identifying each approved brand, such as a name of the brand (a brand name) or an ID of the brand (a brand ID), is registered. FIG. 3 shows an example in which brands having brand names of a “brand A” and a “brand B” are registered. The number of brands registered in the approved brand information 143 is not particularly limited.

Referring back to FIG. 2, the CPU 11, the ROM 12, the RAM 13, and the memory unit 14 are connected to one another via a bus or the like. Here, the CPU 11, the ROM 12, and the RAM 13 constitute a control unit 100 of the POS terminal 10. The control unit 100 implements functions of the POS terminal 10 by the CPU 11 operating according to the control program 141 stored in the ROM 12 or the memory unit 14.

The control unit 100 is connected to an operation unit 15, a display unit 16, a code reader 17, a printer 18, and the like via a bus or the like.

The operation unit 15 includes various operation keys for an operator (user) to input operations. The operation unit 15 includes a closing key as an example of an operation key. The closing key is operated when the registration processing of the commodity is completed and the processing proceeds to the settlement processing. The display unit 16 is a display device such as a liquid crystal display. Under control of the control unit 100, the display unit 16 displays the commodity information (a commodity name, a price, and the like) of a commodity subjected to the registration processing and the accounting information related to the settlement processing. The operation unit 15 may be a touch panel provided on the display unit 16.

The code reader 17 is a device capable of reading a code symbol. For example, code reader 17 acquires a picture (image) of the code symbol and reads (decodes) the code symbol in the picture. In some examples, code reader 17 may read code symbols using red light (for example, infrared light). The code reader 17 reads the code symbol that has been attached to a commodity and a settlement code symbol displayed on the customer terminal 30. The printer 18 is a printing device such as a thermal printer. Under the control of the control unit 100, the printer 18 dispenses a receipt on which the commodity information, the settlement information, and the like related to the commodity subjected to the settlement processing are printed.

The control unit 100 is connected to a communication unit 19 via a bus or the like. The communication unit 19 can be a variety of communication interfaces for connecting with an external device. The communication unit 19 is communicably connected to the store server 20 via the network Na. The communication unit 19 is communicably connected to the code settlement server 40 via the network Nb.

Next, a hardware configuration of the store server 20 will be described. FIG. 4 is a diagram showing an example of the hardware configuration of the store server 20. As shown in FIG. 4, the store server 20 includes a CPU 21, a ROM 22, a RAM 23, and a memory unit 24.

The CPU 21 is an example of a processor and collectively controls operations of the store server 20. The ROM 22 stores various programs executable by the CPU 21. The RAM 23 is a work area for temporarily storing programs and various kinds of data.

The memory unit 24 includes a nonvolatile memory such as an HDD or a flash memory in which stored information is held even when the power supply is turned off. The memory unit 24 stores various programs executable by the CPU 21, setting information, and the like. For example, the memory unit 24 stores a control program 241 executable by the CPU 21. In addition, the memory unit 24 stores a commodity master 242, a transaction history DB (database) 243 for storing and managing the transaction data, and the like. A data structure of the commodity master 242 is the same as that of the commodity master 142. For example, when the commodity master 242 is provided to each POS terminal 10, a copy of commodity master 242 is used as the commodity master 142 in each POS terminal 10.

The CPU 21, the ROM 22, the RAM 23, and the memory unit 24 are connected to one another via a bus or the like. Here, the CPU 21, the ROM 22, and the RAM 23 constitute a control unit 200 of the store server 20. The control unit 200 implements functions of the store server 20 by the CPU 21 operating according to the control program 241 stored in the ROM 22 or the memory unit 24.

The control unit 200 is connected to a communication unit 25 via a bus or the like. The communication unit 25 can be a variety of communication interfaces for connecting with an external device. The communication unit 25 is communicably connected to the POS terminal 10 and the like via the network Na.

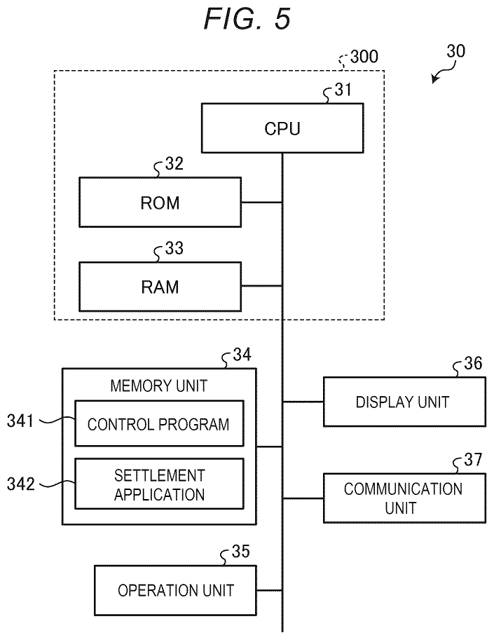

Next, a hardware configuration of the customer terminal 30 will be described. FIG. 5 is a diagram showing an example of the hardware configuration of the customer terminal 30. As shown in FIG. 5, the customer terminal 30 includes a CPU 31, a ROM 32, a RAM 33, and a memory unit 34.

The CPU 31 is an example of a processor and comprehensively controls operations of the customer terminal 30. The ROM 32 stores various programs executable by the CPU 31. The RAM 33 is a work area for temporarily storing programs and various kinds of data.

The memory unit 34 includes a nonvolatile memory such as an HDD or a flash memory in which stored information is held even when the power supply is turned off. The memory unit 34 stores various programs executable by the CPU 31, setting information, and the like. For example, the memory unit 34 stores a control program 341 executable by the CPU 31. The memory unit 34 stores a settlement application 342 for performing code settlement. It is assumed in this example that the settlement application 342 for each code settlement brand used by the customer is individually stored (installed) in the memory unit 34.

The CPU 31, the ROM 32, the RAM 33, and the memory unit 34 are connected to one another via a bus or the like. Here, the CPU 31, the ROM 32, and the RAM 33 constitute a control unit 300 of the customer terminal 30. The control unit 300 implements functions of the customer terminal 30 by the CPU 31 operating according to the control program 341 stored in the ROM 32 or the memory unit 34. The control unit 300 operates according to the application 342 to implement a function activated settlement related to the code settlement such as a displaying of the settlement code symbol by the customer terminal 30.

The control unit 300 is connected to an operation unit 35, a display unit 36, and the like via a bus or the like. The operation unit 35 includes various operation keys for the operator (customer) to input operations. The display unit 36 is a display device such as a liquid crystal display. The display unit 36 displays the settlement code symbol or the like under the control of the control unit 300. The operation unit 35 may be a touch panel provided on the display unit 36.

The control unit 300 is connected to a communication unit 37 via a bus or the like. The communication unit 37 is a variety of communication interfaces for connecting with an external device. The communication unit 37 is communicably connected to a server device of a service company that provides a code settlement service via a network such as a public (non-dedicated) communication line.

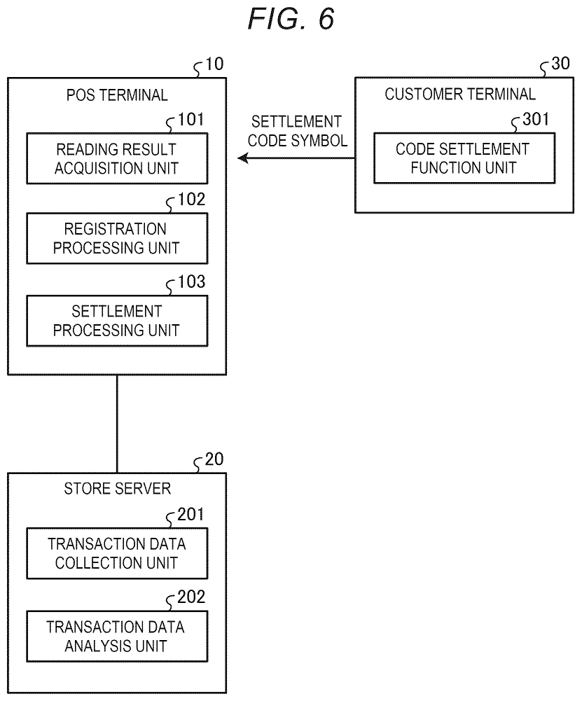

Next, functional aspects of the POS terminal 10, the store server 20, and the customer terminal 30 described above will be described. FIG. 6 is a diagram showing an example of the functional aspects of the POS terminal 10, the store server 20, and the customer terminal 30.

First, the functional aspects of the customer terminal 30 will be described. As shown in FIG. 6, the customer terminal 30 provides the functions of a code settlement function unit 301.

The functional aspects of the customer terminal 30 are implemented by a software configuration executed by a processor of the customer terminal 30 operating according to the control program 341 (and the settlement application 342) stored in the ROM 32 or the memory unit 34, but is not limited thereto. For example, a part or all of the functional aspects of the customer terminal 30 may be implemented by hardware such as a dedicated circuit or the like.

The code settlement function unit 301 is implemented by cooperation between the control program 341 and the settlement application 342. The code settlement function unit 301 executes various kinds of processing related to the code settlement. For example, the code settlement function unit 301 displays a settlement code symbol on the display unit 36 in response to the request or instruction of the operator. The settlement code symbol encodes settlement data used for performing the code settlement. In this context, settlement data includes, for example, information that allows identification of a user ID or the like under which the customer has contracted with a service provider of the code settlement brand of the settlement application 342.

A code settlement function unit 301 can be implemented separately for each brand of settlement applications 342 that can be activated on the customer terminal 30. The code settlement function unit 301 causes the display of the settlement code symbol holding the settlement data corresponding to the brand. For example, the code settlement function unit 301 implemented by the settlement application 342 of “Company A” displays a settlement code symbol encoding the settlement data for Company A. The code settlement function unit 301 implemented by the settlement application 342 of “Company B” displays a settlement code symbol encoding the settlement data for Company B.

Next, the functional configuration of the POS terminal 10 will be described. As shown in FIG. 6, the POS terminal 10 includes a reading result acquisition unit 101, a registration processing unit 102, and a settlement processing unit 103.

The functional aspects of the POS terminal 10 are implemented as a software configuration executed by a processor of the POS terminal 10 operating according to the control program 141 stored in the ROM 12 or the memory unit 14, but is not limited thereto. For example, a part or all of the functional aspects of the POS terminal 10 may be implemented by hardware such as a dedicated circuit.

The reading result acquisition unit 101 is an example of a first acquisition unit and a second acquisition unit. The reading result acquisition unit 101 acquires a reading result read from the code reader 17. For example, the reading result acquisition unit 101 acquires a reading result (e.g., a commodity code) by reading a code symbol attached to a commodity. In addition, the reading result acquisition unit 101 acquires a reading result (settlement data) from the code reader 17 by reading of a settlement code symbol displayed on the customer terminal 30.

The registration processing unit 102 is an example of a registration unit. The registration processing unit 102 executes the registration processing of the item(s) purchased by the customer based on the commodity code(s) acquired by the reading result acquisition unit 101. Specifically, the registration processing unit 102 reads, from the commodity master 142, the commodity information of the commodity corresponding to a commodity code acquired by the reading result acquisition unit 101. Further, the registration processing unit 102 holds (registers) the acquired commodity information in the RAM 13 or the like in association with the commodity code and the purchased quantity of the commodity. The registration processing unit 102 causes the display unit 16 to display the commodity name, the price, the quantity, and the like of each commodity registered in the registration processing in a registration order.

The settlement processing unit 103 is an example of a processing unit and an output unit. The settlement processing unit 103 executes the settlement processing of the commodity registered in the registration processing in response to the operation performed by an operator.

For example, upon receiving the closing operation through the operation unit 15, the settlement processing unit 103 causes the display unit 16 to display a screen on which a settlement method (e.g., cash settlement or code settlement) can be selected. If the cash settlement is selected, the settlement processing unit 103 executes the settlement processing for settling the total amount due for commodities registered in the registration processing by a cash (or the like) payment amount deposited into a deposit device, cash handling machine, or the like. Further, the settlement processing unit 103 dispenses a customer receipt and a store-reserved receipt.

Here, the customer receipt is a receipt to be handed over to the customer who purchases the commodities. For example, a shop name, a transaction date and time when a transaction is made, an item of the purchased commodity (a commodity name), a unit price, and a payment amount are printed. The store-reserved receipt is a sheet for recording a transaction record, and is also referred to as a journal or transaction journal. A content of the store-reserved receipt may be the same as that of the customer receipt or may just be partial information extracted from the content of the customer receipt. For example, the store-reserved receipt may be printed with the transaction date and time or the total amount of the commodities (the payment amount). When not distinguishing between the customer receipt and the store-reserved receipt, each may be simply referred to as receipts.

If code settlement is selected, the settlement processing unit 103 cooperates with the reading result acquisition unit 101 and waits until the settlement data is acquired. After the reading result acquisition unit 101 acquires the settlement data, the settlement processing unit 103 transmits the settlement data together with the total amount due for the commodities (the requested payment amount) to the code settlement server 40, thereby requesting the code settlement server 40 to perform code settlement for the requested payment amount. The settlement server is generally designated in or by the settlement data.

Upon receiving a notification of settlement completion (hereinafter, also referred to as a settlement completion notification) from the code settlement server 40, the settlement processing unit 103 determines that the code settlement for the total amount has been completed, and dispenses the customer receipt and the store-reserved receipt. The settlement completion notification includes, for example, brand information indicating the used code settlement brand in addition to the payment amount paid using the code payment (that is, the total amount due for the commodities). If the code settlement server 40 notifies a failure of the code settlement, the settlement processing unit 103 causes the display unit 16 to display a message notifying the failure of the code settlement. If the code settlement server 40 notifies the failure of the code settlement, the settlement processing unit 103 may prompt the user to select another settlement method by displaying a settlement method selection screen again.

Once the settlement processing is completed, the settlement processing unit 103 generates transaction data indicating details of the transaction and stores (records) the transaction data in the memory unit 14. The transaction data stored in the memory unit 14 is transmitted to the store server 20 at a predetermined timing under the control of the settlement processing unit 103 or the control unit 100.

In the checkout area or the like in which the POS terminal 10 is set, code settlement brands that can be used in the store are generally promoted (advertised). In this case, a customer who wants to perform a code settlement generally checks the promoted brands and activates the corresponding settlement application on his or her customer terminal 30 to perform the code settlement with an appropriate brand.

However, if the settlement applications for a plurality of brands are on the customer terminal 30, the settlement application of a brand that is not approved by the store may be activated due to an erroneous operation or the like, and a settlement code symbol may be generated and displayed for an unapproved brand. In this case, at the POS terminal 10, a store clerk may then carelessly read the settlement data from the settlement code symbol, and the settlement data will be transmitted to the code settlement server 40. If the code settlement server 40 supports the code settlement for the brand of the settlement data transmitted from the POS terminal 10, the code settlement may be performed even though the brand is not approved in the store.

In such a case, from the viewpoint of customer convenience, if the settlement result of the code settlement server 40 indicates the settlement completion, even though an unapproved brand was used, the settlement processing may appear to proceed as in a normal settlement processing using an approved code settlement brand. However, on the store side, it is usually necessary to perform additional post-processing such as payment of a service fee for use of an unapproved brand, and thus it may be desired to be able to identify in which transaction(s) an unapproved brand is used.

Upon receiving the settlement completion notification from the code settlement server 40, the settlement processing unit 103 in the present embodiment compares the brand information included in the settlement completion notification with the brand information registered in the approved brand information 143 to determine whether the brand used for the code settlement corresponds to any of the approved brands.

Here, if the brand information included in the settlement completion notification matches any of the brand information registered in the approved brand information 143, the approved brand information 143 identifies that an approved brand was used for code settlement. In this case, the settlement processing unit 103 dispenses various receipts and records the transaction data by executing prescribed settlement processing.

On the other hand, if the brand information included in the settlement completion notification does not match any of the brand information registered in the approved brand information 143, the approved brand information 143 identifies that an unapproved brand was used for code settlement.

In this case, the settlement processing unit 103 notifies the operator of the POS terminal 10 by displaying a notification screen for notifying that the unapproved brand was used for the code settlement on the display unit 16. The settlement processing unit 103 adds information capable of identifying that the unapproved brand was used for the code settlement to the store-reserved receipt and dispenses the receipt. Further, the settlement processing unit 103 adds information capable of identifying that the unapproved brand was used for the code settlement to the generated transaction data and records the transaction data.

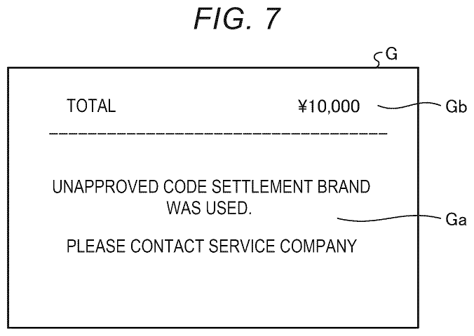

Here, a notification screen displayed when the unapproved brand was used for code settlement will be described with reference to FIG. 7. FIG. 7 is a diagram showing an example of a screen displayed on the display unit 16 of the POS terminal 10.

When it is determined that an unapproved brand is used for the code settlement, the settlement processing unit 103 causes the display unit 16 to display a notification screen G shown in FIG. 7. Specifically, the settlement processing unit 103 notifies that an unapproved brand was used by display of the notification screen G or the like. The settlement processing unit 103 also displays a message Ga with text or the like for prompting contacting a service company corresponding to the code settlement brand or the like. The settlement processing unit 103 also displays, on the notification screen G, a payment amount Gb (a total amount due for purchased commodities) that was paid using the unapproved code settlement.

Accordingly, by viewing the notification screen G, the operator of the POS terminal 10 can easily grasp that an unapproved brand was used for the code settlement and see the amount paid using the unapproved code settlement brand. Therefore, the POS terminal 10 can improve identifiability of the transactions in settlement which was performed using an unapproved brand.

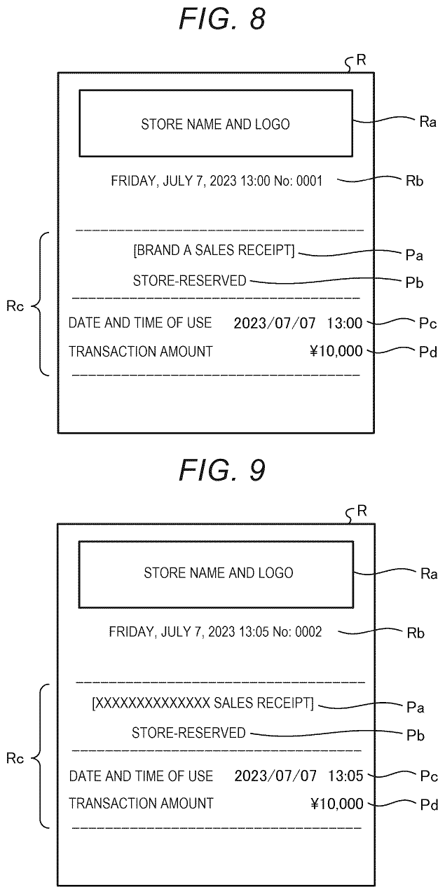

Next, with reference to FIGS. 8 and 9, an example of a store-reserved receipt dispensed when code settlement is performed will be described.

FIG. 8 is a diagram showing an example of a store-reserved receipt. This example of a store-reserved receipt is dispensed if the code settlement is performed with an approved brand. FIG. 9 is a diagram showing another example of a store-reserved receipt. This example of a store-reserved receipt is dispensed if the code settlement is performed with an unapproved brand.

As shown in FIGS. 8 and 9, a store-reserved receipt R has a first area Ra (in which store information, a logo mark, and the like are printed) and a second area Rb (in which a date and time of the transaction and a transaction number for identifying the transaction are printed).

The store-reserved receipt R has a third area Rc in which transaction content (details) is printed. The third area Rc includes a title area Pa in which a designation, name, or identifier of receipt can be printed, a receipt type area Pb in which information indicating that the receipt is a store-reserved receipt is printed, a settlement date and time area Pc in which the date and time of the transaction is printed, and a transaction amount area Pd in which a payment amount (transaction amount) is printed.

Here, in the title area Pa, the settlement method used in the transaction and/or other information designating the sales receipt as related to the sales of the commodities in the transaction can be printed. For example, if code settlement is performed with the approved brand “brand A”, then “brand A” or other information indicating a brand name of the code settlement used can be printed in the title area Pa (see FIG. 8). Such a brand name or related information can be read, for example, from the brand information identified by comparing the settlement completion notification to the approved brand information 143.

On the other hand, if the code settlement is performed with the unapproved brand, as shown in FIG. 9, a brand name of the code settlement used as the settlement method is printed in the arbitrary form of “XXXXXXXXXXXX” or the like in the title area Pa. In this way, if an unapproved brand is used, the settlement processing unit 103 uses a predetermined character string (also referred to as a flag character string) and prints this character string in the title area Pa. Accordingly, a person in charge such as a store clerk who performs the post-processing related to transactions can easily determine whether code settlement with an approved or unapproved brand was used by checking the brand name (or other information) displayed in the title area Pa.

The output form of the store-reserved receipt R is not limited to the above example. For example, if the code settlement is performed with an unapproved brand, the settlement processing unit 103 may print a part or all of the brand information (the brand name and the brand ID) included in the settlement completion notification in the title area Pa. However, in this case as well, it is preferable that the settlement processing unit 103 adds a easily identifiable flag character string such as “XX” to the beginning of the printed brand information, so that the unapproved brand is easily distinguishable from approved brands.

In the above example, the title area Pa is used to output information capable of identifying whether the code settlement brand is approved or not, but an output destination is not limited thereto. For example, information indicating the brand name of the code settlement used in the transaction or the unapproved brand may be printed at the beginning of the receipt type area Pb. In still other examples, information indicating the brand name of the code settlement used in the transaction or the unapproved brand may be printed in the third area Rc or elsewhere.

The information included in the store-reserved receipt R is not limited to the above example. For example, the store-reserved receipt R may additionally include information such as a terminal ID capable of identifying the particular POS terminal 10 on which the settlement processing was performed and a store clerk ID capable of identifying the store clerk who operated the POS terminal 10.

The settlement processing unit 103 may use a method similar to that of the store-reserved receipt R described above for adding information capable of identifying that an unapproved brand was used for the code settlement to the transaction data. Specifically, if an unapproved brand is used for code settlement, the settlement processing unit 103 adds a predetermined flag character string to an input field for the code settlement brand name included in the transaction data. Thus, an unapproved brand is identifiable from the approved brand in the transaction data. In some examples, when an unapproved brand is used for the code settlement, the settlement processing unit 103 inputs a part or all of the brand information included in the settlement completion notification together with the flag character string in the input field for the brand name included in the transaction data.

A customer receipt also includes an area displaying information the same as that of the first area Ra, the second area Rb, and the third area Rc described above, and information capable of identifying that an unapproved brand was used for the code settlement may or may not be printed on the customer receipt. For example, the brand name of each brand registered in the approved brand information 143 may be added as a usable code settlement brand together with (or instead of) printing of the information capable of identifying the unapproved brand. Accordingly, since the settlement processing unit 103 can cause the customer to recognize that some brands are usable in the store, it is possible to call attention to the use of the unapproved brand for the next and subsequent transactions.

Next, functional aspects of the store server 20 will be described. As shown in FIG. 6, the store server 20 includes a transaction data collection unit 201 and a transaction data analysis unit 202.

The functional aspects of the store server 20 is implemented as a software configuration executed by a processor of the store server 20 operating according to the control program 241 stored in the ROM 22 or the memory unit 24, but is not limited thereto. For example, a part or all of the functions of the store server 20 may be implemented by hardware such as a dedicated circuit.

The transaction data collection unit 201 acquires (collects) the transaction data from each of the POS terminals 10 and stores the transaction data in the transaction history DB 243. For example, the transaction data collection unit 201 acquires the transaction data transmitted from each of the POS terminals 10 and stores the transaction data in the transaction history DB 243. For example, the transaction data collection unit 201 acquires the transaction data transmitted from the POS terminal 10 by requesting the transaction data to be sent from each of the POS terminals 10, and then stores the acquired transaction data in the transaction history DB 243.

The transaction data analysis unit 202 analyzes the transaction data stored in the transaction history DB 243 and outputs an analysis result to a file or the like. For example, the transaction data analysis unit 202 calculates a total sales amount for one day by adding up the payment amounts (a transaction amount) included in the transaction data for the day (for example, the previous day) registered in the transaction history DB 243. For example, the transaction data analysis unit 202 calculates a total sales amount for each settlement method by adding up, for each settlement method, the payment amounts (transaction amounts) included in the transaction data for the day (for example, the previous day) registered in the transaction history DB 243.

The transaction data analysis unit 202 can extract the transaction data of those transactions in which an unapproved brand was used based on the information related to code settlement included in the transaction data for each transaction. For example, the transaction data analysis unit 202 extracts, from the transaction history DB 243, the transaction data for which the predetermined flag character string indicating an unapproved brand was input in the input field of the brand name. For example, after the transaction data analysis unit 202 extracts this transaction data, the transaction data analysis unit 202 classifies and extracts the transaction data for each unapproved brand based on the brand information input field.

As described above, since the transaction data generated by the POS terminal 10 includes information capable of identifying transactions using an unapproved brand, it is possible to easily extract the transaction data involving code settlement performed using unapproved brands. Therefore, in the sales data processing system 1, it is possible to efficiently perform post-processing such as determining payments of service fees relating to use of an unapproved brand for code settlement.

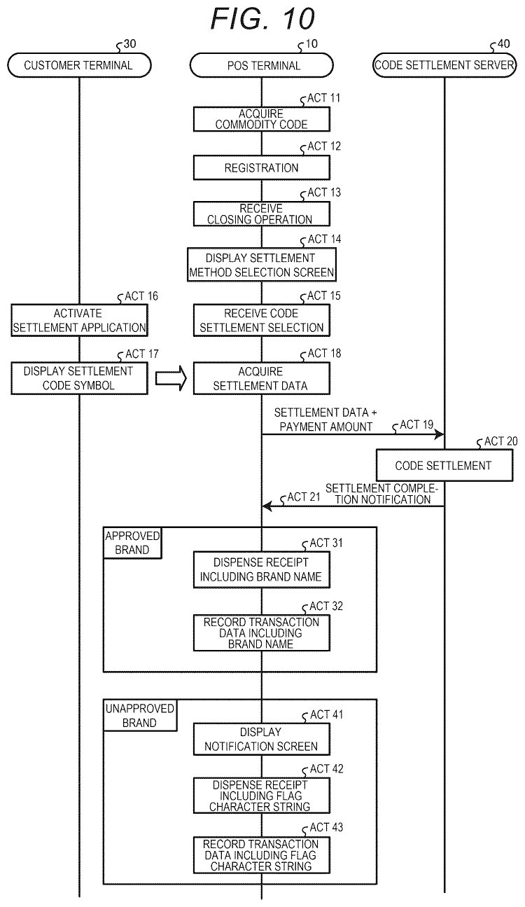

Next, processing executed in the sales data processing system 1 will be described. FIG. 10 is a sequence diagram showing an example of the flow of the processing executed in the sales data processing system 1. The processing shows an example of when code settlement is performed.

First, in the POS terminal 10, after a commodity code is read by the code reader 17 from a code symbol attached to a commodity being purchased by a customer, the reading result acquisition unit 101 acquires the read commodity code (ACT 11). Next, the registration processing unit 102 executes registration processing based on the commodity code acquired (ACT 12).

The POS terminal 10 executes the processing of ACT 11 and ACT 12 each time a commodity code is read. Once the POS terminal 10 receives a closing operation through the operation unit 15 (ACT 13), the settlement processing unit 103 causes the display unit 16 to displays a settlement method selection screen on which a settlement method can be selected (ACT 14).

Here, code settlement is selected from the settlement method selection screen in ACT 15, the settlement processing unit 103 thus cooperates with the reading result acquisition unit 101 and waits until the settlement data is input to the POS terminal 1.

The activation of the settlement application 342 is instructed by an operation of the customer and the control unit 300 of the customer terminal 30 activates the instructed settlement application 342 to implement the code settlement function unit 301 (ACT 16). Subsequently, the code settlement function unit 301 causes the display unit 36 to display a settlement code symbol (ACT 17).

When the settlement code symbol displayed on the customer terminal 30 is held over the code reader 17 of the POS terminal 10, the code reader 17 reads the settlement data from the settlement code symbol. Next, the reading result acquisition unit 101 acquires the settlement data as read by the code reader 17 (ACT 18).

The settlement processing unit 103 transmits the settlement data (acquired in ACT 18) together with a total amount due (a payment amount) to the code settlement server 40, thereby requesting the code settlement server 40 to perform a code settlement (ACT 19).

Upon receiving the settlement data and the payment amount from the POS terminal 10, the code settlement server 40 executes the code settlement for the payment amount based on the transmitted settlement data (ACT 20). Further, the code settlement server 40 transmits, to the POS terminal 10, a settlement completion notification including brand information of the brand used for the code settlement (ACT 21).

Upon receiving the settlement completion notification from the code settlement server 40, the settlement processing unit 103 of the POS terminal 10 compares the brand information included in the settlement completion notification with the brand information registered in the approved brand information 143 to determine whether the code settlement was performed with an approved brand.

If it is determined that the code settlement was performed with an approved brand, the settlement processing unit 103 dispenses a receipt including a brand name or the like (ACT 31). Furthermore, the settlement processing unit 103 generates transaction data including the brand name and records the transaction data in the memory unit 14, the store server 20, or the like (ACT 32).

On the other hand, if it is determined that the code settlement was performed with an unapproved brand, the settlement processing unit 103 causes the display unit 16 to display information notifying that the code settlement was performed with an unapproved brand (ACT 41). Next, the settlement processing unit 103 dispenses a receipt including a flag character string or the like indicating that the code settlement was performed with an unapproved brand (ACT 42). Further, the settlement processing unit 103 generates the transaction data including the flag character string and records the transaction data in the memory unit 14, the store server 20, or the like (ACT 43).

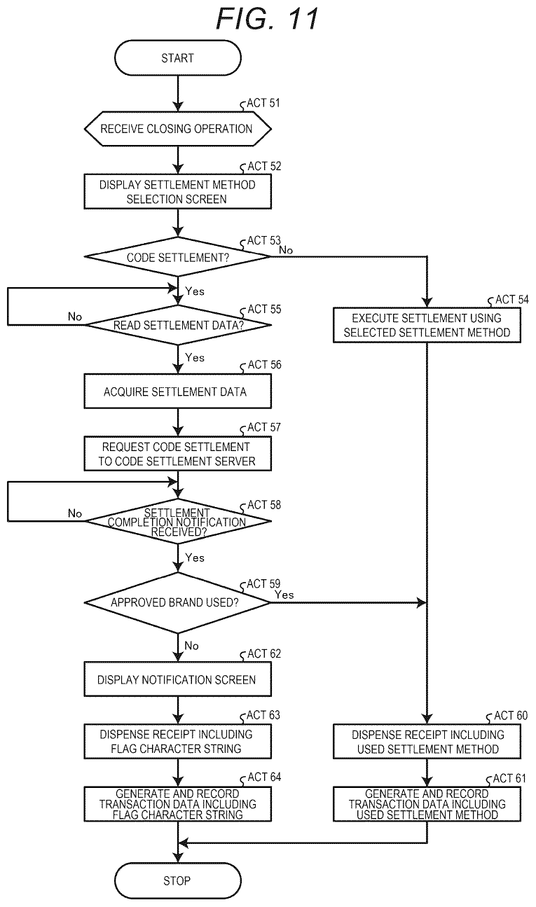

Next, the sales data processing performed by the POS terminal 10 will be described with reference to FIG. 11. FIG. 11 is a flowchart showing an example of sales data processing performed by the POS terminal 10. The processing corresponds to the processing after ACT 13 as performed by the POS terminal 10 in FIG. 10.

If it is determined that the closing operation is received through the operation unit 15 (ACT 51), the settlement processing unit 103 causes the display unit 16 to display the settlement method selection screen (ACT 52), and waits until a settlement method is selected.

Here, if a settlement method other than the code settlement, such as cash settlement, is selected (ACT 53; No), the settlement processing unit 103 executes the settlement processing by the selected settlement method (ACT 54), and the processing proceeds to ACT 60.

If code settlement is selected (ACT 53; Yes), the settlement processing unit 103 then waits (ACT 55; No) until the settlement data is read. Here, once the settlement data is read by the code reader 17 (ACT 55; Yes), the reading result acquisition unit 101 acquires the settlement data (ACT 56).

Subsequently, the settlement processing unit 103 transmits the settlement data (acquired in ACT 49) together with a payment amount to the code settlement server 40, thereby requesting the code settlement server 40 to perform a code settlement (ACT 57). Next, the settlement processing unit 103 waits (ACT 58; No) until the settlement completion notification is received from the code settlement server 40.

Upon receiving the settlement completion notification (ACT 58; Yes), the settlement processing unit 103 compares the brand information included in the settlement completion notification with the brand information registered in the approved brand information 143 to determine whether the code settlement was performed with an approved brand (ACT 59).

Here, if it is determined that the code settlement was performed with an approved brand (ACT 59; Yes), the settlement processing unit 103 causes the processing to proceed to ACT 60. In ACT 60, the settlement processing unit 103 dispenses a receipt including information indicating the settlement method used and the like (ACT 60). For example, if the settlement method was cash settlement, the settlement processing unit 103 dispenses a receipt indicating the cash settlement details, such as a deposited amount, a change due amount, and the like. If the settlement method used is a code settlement, the settlement processing unit 103 dispenses a receipt indicating details such as the brand name or the like as identified by the comparison in ACT 59.

After the transaction data including the settlement method used and the like is generated, the settlement processing unit 103 records the transaction data in the memory unit 14, the store server 20, or the like (ACT 61), and the processing ends.

On the other hand, if it is determined that the code settlement was performed with an unapproved brand (ACT 59; No), the settlement processing unit 103 causes the display unit 16 to display a notification screen notifying that the code settlement was performed with an unapproved brand (ACT 62). Next, the settlement processing unit 103 dispenses a receipt including a predetermined flag character string or the like indicating that the code settlement was performed with an unapproved brand (ACT after 63). Furthermore, the transaction data including predetermined flag information and the like is generated, the settlement processing unit 103 records the transaction data in the memory unit 14, the store server 20, or the like (ACT 64), and the processing ends.

As described above, the POS terminal 10 acquires the settlement data from the settlement code symbol, transmits the acquired settlement data to the code settlement server 40 to request the code settlement server 40 to execute the code settlement, and receives a settlement result notification including the brand used in the code settlement from the code settlement server 40. If the code settlement brand indicated in the settlement result notification does not match a brand registered in the approved brand information 143, the POS terminal 10 outputs information that indicates that the code settlement was performed with an unapproved brand.

Accordingly, if an unapproved brand is used in the code settlement at the POS terminal 10, it is possible to notify or record that the code settlement was performed with an unapproved brand using any one, or all, of a display screen output, a print output, and a data output. Therefore, the POS terminal 10 can improve identifiability of the transactions using an unapproved brand for code settlement.

The described embodiments can be appropriately modified and implemented by changing a part of the configuration or function of each of the above-described apparatuses. Hereinafter, some modifications will be described as additional embodiments. In the following, points different from those already described will be highlighted, and detailed description of points common to the already described examples may be omitted. The modifications described may be implemented individually or in combination with each other as appropriate.

### Modification 1

In an embodiment, the POS terminal 10 is a device operated by a store employee such as a store clerk. However, the POS terminal 10 is not limited thereto, and may be a self-service POS terminal operated by a customer.

In the case of a self-service POS terminal 10, the settlement processing unit 103 need not display a notification message on the display unit 16 when the unapproved brand is used for the code settlement.

In an embodiment, the POS terminal 10 performs the registration processing and the settlement processing, but the embodiments are not limited thereto. The configuration may be such that the registration processing and the settlement processing are performed by different devices. In this case, in the POS terminal 10 (also referred to here as a registration device) that performs the settlement processing, by performing the processing same after the closing operation as described, when code settlement is performed with an unapproved brand, an operator can be notified and a receipt and transaction data can still be recorded indicating the use of the unapproved brand.

The programs executed by each device in the above-described embodiments (and modifications) can be provided by being incorporated in advance in a ROM, a memory, or the like or may be provided in a non-transitory, computer-readable recording medium such as a CD-ROM, a flexible disk (FD), a CD-R, or a digital versatile disk (DVD) as a file in an installable or executable format.

Furthermore, the programs executed by each device may be provided by being stored in a computer connected to a network, such as the Internet, and downloaded or otherwise accessed via the network. The programs executed by each device may be provided or distributed via a network such as the Internet.

While certain embodiments have been described, these embodiments have been presented by way of example and are not intended to limit the scope of the disclosure. These novel embodiments and modifications can be implemented in various other forms, and various omissions, replacements, changes, and combinations can be made without departing from the gist of the disclosure. The embodiments and the modifications thereof are included in the scope and the gist of the disclosure, and are included in a scope of the presented claims and equivalents thereof.

What is claimed is:

1. A sales data processing apparatus, comprising:
a communication interface; and
a processor configured to:
acquire settlement data associated with a code symbol read from a customer terminal, the settlement data including information for completing a code settlement payment for a sales transaction;
transmit the settlement data via the communication interface to an external server that provides a settlement proxy service of the code settlement payment;
receive a settlement result notification via the communication interface from the external server, the settlement result notification including a code settlement brand used for the code settlement payment;
compare the code settlement brand in the settlement result notification to a listing of approved brands; and
output a notification that the code settlement payment was performed using an unapproved code settlement brand when the code settlement brand included in the settlement result notification does not match an approved brand on the listing.

2. The sales data processing apparatus according to claim 1, wherein the notification output is a printed notification that indicates that the code settlement payment was performed with the unapproved code settlement brand.

3. The sales data processing apparatus according to claim 1, wherein, if the code settlement payment was performed with an approved code settlement brand, the notification output is a printed notification including the code settlement brand used for the code settlement payment.

4. The sales data processing apparatus according to claim 3, wherein, if the code settlement was performed with the unapproved code settlement brand, the notification output is a printed notification including a predetermined flag character string.

5. The sales data processing apparatus according to claim 1, further comprising:
a display unit, wherein
the notification output includes a notice displayed by the display unit indicating that the code settlement payment was performed with the unapproved code settlement brand.

6. The sales data processing apparatus according to claim 1, further comprising:
a product scanner to acquire commodity identification information identifying a commodity to be purchased in the sales transaction from a product code symbol attached to the commodity.

7. The sales data processing apparatus according to claim 6, wherein the code symbol is read from the customer terminal by the product scanner.

8. The sales data processing apparatus according to claim 6, wherein the processor is further configured to:
register the commodity to be purchased in the sales transaction.

9. The sales data processing apparatus according to claim 1, wherein the settlement data includes a total transaction amount due for the sales transaction.

10. A point-of-sale terminal, comprising:
a printer;
a communication interface;
an optical scanner; and
a processor configured to:
acquire settlement data associated with a code symbol read from a customer terminal by the optical scanner, the settlement data including information for completing a code settlement payment for a sales transaction;
transmit the settlement data via the communication interface to an external server that provides a settlement proxy service of the code settlement payment;
receive a settlement result notification via the communication interface from the external server, the settlement result notification including a code settlement brand used for the code settlement payment;
compare the code settlement brand in the settlement result notification to a listing of approved brands; and
output a notification via the printer that the code settlement payment was performed using an unapproved code settlement brand when the code settlement brand included in the settlement result notification does not match an approved brand on the listing.

11. The point-of-sale terminal according to claim 10, wherein if the code settlement was performed with the unapproved code settlement brand, the notification includes a predetermined flag character string on a journal receipt.

12. The point-of-sale terminal according to claim 10, further comprising:
a display unit, wherein
the processor causes the display unit to display a notice indicating that the code settlement payment was performed with the unapproved code settlement brand.

13. A sales data processing method, comprising:
acquiring settlement data associated with a code symbol read from a customer terminal, the settlement data including information for completing a code settlement payment for a sales transaction;
transmitting the settlement data via a communication interface to an external server that provides a settlement proxy service of the code settlement payment;
receiving a settlement result notification via the communication interface from the external server, the settlement result notification including a code settlement brand used for the code settlement payment;
comparing the code settlement brand in the settlement result notification to a listing of approved brands; and
outputting a notification that the code settlement payment was performed using an unapproved code settlement brand when the code settlement brand included in the settlement result notification does not match an approved brand on the listing.

14. The sales data processing method according to claim 13, wherein the notification output is a printed notification that indicates that the code settlement payment was performed with the unapproved code settlement brand.

15. The sales data processing method according to claim 13, wherein, if the code settlement payment was performed with an approved code settlement brand, the notification output is a printed notification including the code settlement brand used for the code settlement payment.

16. The sales data processing method according to claim 15, wherein, if the code settlement was performed with the unapproved code settlement brand, the notification output is a printed notification including a predetermined flag character string.

17. The sales data processing method according to claim 13, wherein the notification output includes a notice displayed by a display unit indicating that the code settlement payment was performed with the unapproved code settlement brand.

18. The sales data processing method according to claim 13, further comprising:
acquiring commodity identification information identifying a commodity to be purchased in the sales transaction from a product code symbol attached to the commodity.

19. The sales data processing method according to claim 13, wherein the code symbol is read from the customer terminal by a product scanner.

20. The sales data processing method according to claim 13, further comprising:
registering a commodity to be purchased in the sales transaction.
